(19) United States
(12) Patent Application Publication
(10) Pub. No.: US 2017/0201647 A1
(43) Pub. Date: Jul. 13, 2017

(54) SYSTEMS AND METHODS FOR GEOFENCING FOR SERVICE AVAILABILITY AND DYNAMIC PROFIT CALCULATION

(71) Applicant: FUJI XEROX CO., LTD., Tokyo (JP)

(72) Inventors: Russell Shane Neville, Newberg, OR (US); Chad Eickhoff, Portland, OR (US); Ashok Murthy, Union City, CA (US)

(21) Appl. No.: 14/995,189

(22) Filed: Jan. 13, 2016

(51) Int. Cl. H04N 1/34; G06Q 20/08; H04N 1/00

(52) U.S. Cl. CPC H04N 1/346; H04N 1/348; H04N 1/00344; G06Q 20/085; H04N 2201/3253; H04N 2201/0082; H04N 2201/0039

(57) ABSTRACT

Described is a system for managing a printing service incorporating: a network-connected printer disposed on a local area network, a cloud-based printing service managing a printing queue holding at least one print job, a service provider smart device and a network-connected appliance device disposed on the local area network and communicatively coupled with the network-connected printer, the network-connected appliance device being configured to determine a status of the network-connected printer, connect to the cloud-based printing service and communicate the determined status of the network-connected printer to the cloud-based printing service. The service provider smart device is configured to generate a graphical user interface on the display and receive, using the generated graphical user interface, a printing service information from a service provider and to communicate the received printing service information to the cloud-based printing service.

### BACKGROUND OF THE INVENTION

Technical Field

The disclosed embodiments relate in general to cloud services technology and, more specifically, to systems and methods for geofencing for service availability and dynamic profit calculation.

Description of the Related Art

Most of high-cost computer peripheral devices, such as printers and scanners, owned by individual users sit idle 99% of the time. Offering the use of such devices to other individual users for a fee on an ad-hock basis would help offsetting the high costs of their acquisition and maintenance. Unfortunately, conventional technology does not provide convenient tools that would enable individual users to easily offer their peripheral devices to other individual users on an on-demand basis.

As would be appreciated by persons of skill in the art, in view of the aforesaid shortcomings of the conventional technology, it would be advantageous to have new and improved systems and methods for facilitating computer peripheral device sharing by individual users on an on-demand basis.

### SUMMARY OF THE INVENTION

The embodiments described herein are directed to methods and systems that substantially obviate one or more of the above and other problems associated with conventional technology.

In accordance with one aspect of the inventive concepts described herein, there is provided a computerized system for managing a printing service, the system incorporating: a network-connected printer disposed on a local area network; a cloud-based printing service comprising a printing queue holding at least one print job; a service provider smart device comprising a first processing unit, a first memory and a display; and a network-connected appliance device disposed on the local area network and communicatively coupled with the network-connected printer, the network-connected appliance device incorporating a second processing unit and a second memory and configured to determine a status of the network-connected printer, connect to the cloud-based printing service and communicate the determined status of the network-connected printer to the cloud-based printing service. The service provider smart device is configured to generate a graphical user interface on the display and receive, using the generated graphical user interface, a printing service information from a service provider and to communicate the received printing service information to the cloud-based printing service.

In one or more embodiments, the printing service information comprises availability options of the printing service.

In one or more embodiments, the availability options comprise days and hours of availability of the printing service.

In one or more embodiments, the printing service information comprises pricing information of the printing service.

In one or more embodiments, the printing service information comprises pricing information of the printing service.

In one or more embodiments, the printing service information comprises location information of the printing service.

In one or more embodiments, the printing service information comprises a description of the network-connected printer.

In one or more embodiments, the cloud-based printing service is configured to transmit the communicated printing service information to at least one service user smart device.

In one or more embodiments, the service provider smart device is further configured to obtain pricing information associated with consumables for the network-connected printer and to automatically calculate cost associated with the printing service.

In one or more embodiments, the service provider smart device is further configured to obtain pricing information associated with consumables for the network-connected printer and to automatically calculate profit associated with the printing service.

In one or more embodiments, the pricing information associated with consumables for the network-connected printer is received from the service provider.

In one or more embodiments, the pricing information associated with consumables for the network-connected printer is received from a third party ecommerce system.

In one or more embodiments, the service provider smart device is configured to detect a current geo-location and to automatically communicate to the cloud-based printing service that the printing service is available when the detected current geo-location is within a predetermined vicinity of the network-connected appliance device or the network-connected printer.

In one or more embodiments, when the printing service is available, the one or more print jobs could be sent to the network-connected printer.

In one or more embodiments, the service provider smart device is configured to detect a current geo-location and to automatically communicate to the cloud-based printing service that the printing service is unavailable when the detected current geo-location is outside a predetermined vicinity of the network-connected appliance device or the network-connected printer.

In one or more embodiments, when the printing service is unavailable, the one or more print jobs are prevented from being sent to the network-connected printer.

In one or more embodiments, the computerized system further comprises a service user smart device configured to detect a current geo-location and display the network-connected printer as available to a service user when the detected current geo-location is within a predetermined vicinity of the network-connected appliance device or the network-connected printer.

In one or more embodiments, the computerized system further comprises a service user smart device configured to detect a current geo-location and display the network-connected printer as unavailable to a service user when the detected current geo-location is outside of a predetermined vicinity of the network-connected appliance device or the network-connected printer.

In one or more embodiments, the computerized system further comprises a service user smart device configured to detect a first geo-location, wherein the service provider smart device is configured to detect a second geo-location and wherein the service user smart device is configured to display the network-connected printer as available to a service user when both the detected first geo-location is within a predetermined first vicinity of the network-connected appliance device or the network-connected printer and the detected second geo-location is within a predetermined second vicinity of the network-connected appliance device or the network-connected printer.

In one or more embodiments, the computerized system further comprises a service user smart device configured to detect a first geo-location, wherein the service provider smart device is configured to detect a second geo-location and wherein the service user smart device is configured to display the network-connected printer as unavailable to a service user when either the detected first geo-location is outside of a predetermined first vicinity of the network-connected appliance device or the network-connected printer or the detected second geo-location is outside a predetermined second vicinity of the network-connected appliance device or the network-connected printer.

In accordance with another aspect of the inventive concepts described herein, there is provided a computer-implemented method for managing a printing service, the computer-implemented method performed in connection with a computerized system incorporating: a network-connected printer disposed on a local area network, a cloud-based printing service managing a printing queue holding at least one print job, a service provider smart device incorporating a first processing unit, a first memory and a display and a network-connected appliance device disposed on the local area network and communicatively coupled with the network-connected printer, the network-connected appliance device incorporating a second processing unit and a second memory. The aforesaid computer-implemented method involves: determining, by the network-connected appliance device, a status of the network-connected printer, connect to the cloud-based printing service and communicate the determined status of the network-connected printer to the cloud-based printing service; generating, by the service provider smart device, a graphical user interface on the display and receiving, using the generated graphical user interface, a printing service information from a service provider; and communicating the received printing service information to the cloud-based printing service.

In accordance with yet another aspect of the inventive concepts described herein, there is provided a non-transitory computer-readable medium embodying a set of computer-executable instructions, which, when executed in connection with a computerized system incorporating: a network-connected printer disposed on a local area network, a cloud-based printing service incorporating a printing queue holding at least one print job, a service provider smart device incorporating a first processing unit, a first memory and a display and a network-connected appliance device disposed on the local area network and communicatively coupled with the network-connected printer, the network-connected appliance device incorporating a second processing unit and a second memory, cause the computerized system to perform a method for managing a printing service. The aforesaid method involves: determining, by the network-connected appliance device, a status of the network-connected printer, connect to the cloud-based printing service and communicate the determined status of the network-connected printer to the cloud-based printing service; generating, by the service provider smart device, a graphical user interface on the display and receiving, using the generated graphical user interface, a printing service information from a service provider; and communicating the received printing service information to the cloud-based printing service.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates a logical diagram of an exemplary embodiment of a system for geofencing for service availability and dynamic profit calculation.

FIG. 2(a) illustrates an exemplary operating sequence of an algorithm for automatic geolocation of service availability performed in connection with the embodiments of the system illustrated in FIG. 1.

FIG. 2(b) illustrates an exemplary operating sequence of an algorithm for setting up printer service offer performed in connection with the embodiments of the system illustrated in FIG. 1.

FIG. 3 illustrates the geofencing aspect of the embodiments of the system illustrated in FIG. 1.

FIGS. 4(a), 4(b), 4(c), 4(d), 4(e), 4(f), 4(g), 4(h) and 4(i) illustrate exemplary embodiments of the various screens of graphical user interface generated on the service provider smart device.

FIGS. 5(a) and 5(b) illustrate exemplary embodiments of the various screens of graphical user interface generated on the service provider smart device.

FIG. 6 illustrates an exemplary embodiment of a computerized system that could be used as the smart device or the network-connected appliance in connection with the system shown in FIG. 1.

FIG. 7 illustrates an exemplary embodiment of a computerized server system which could be used, for example, as a computer platform for the cloud service or cloud document repositories of the system shown in FIG. 1.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

For a service provider to offer a printing service on an ad-hoc basis and hope to be profitable they will need supporting tools to enable them to do just that. The service provider can be anyone who has a supported printer that, under normal circumstances, sits idle the majority of the time and is a sunk cost for the service provider. Imagine, though, if one could offer to the public usage of their printer and at the same time make a profit from this otherwise idle and costly device. In order to be profitable, there are multiple factors that need to be calculated and presented to the service provider so they can make educated decisions about how to price their print service. Because this is an open market scenario where many service providers can be offering the same or similar service, it is important that a service provider have visibility as to how competition is pricing their offering so they can remain competitive.

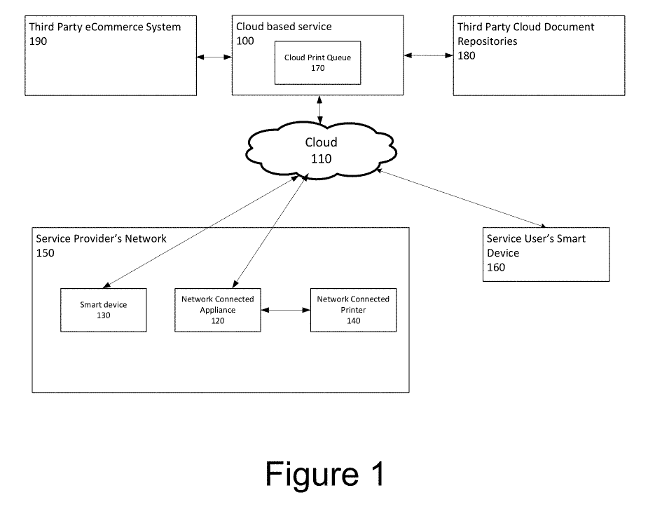

Additionally, as would be appreciated by persons of ordinary skill in the art, for a printing service that is available on an ad hoc basis, there is a challenge to determine when the service is available for a user of that service. Imagine a case where a print service is offered in a college dormitory by a student. The printing service may include a network printer (140 in FIG. 1) that the college student wishes to monetize by offering a print service to share their printer and charge a cost per print. The network printer 140 is connected to a service network through a small appliance (network-connected 120 appliance in FIG. 1) also attached to the network. This appliance 120 collects status of the network printer 140 and connects to a cloud service 100 in order to publish the availability of the printer to the service network. The student's hours are variable and may change day-to-day. The print service is only available when the student is in her room. Even though she may attempt to publish a schedule of availability, the highly variable nature of her schedule poses a problem to providing a reliable service to an end user.

Therefore, in accordance with one aspect of the embodiments described herein, there are provided systems and methods for geofencing for service availability and dynamic profit calculation. FIG. 1 illustrates a logical diagram of an exemplary embodiment of a system for geofencing for service availability and dynamic profit calculation. The system shown in FIG. 1 incorporates a service provider network 150, which may be co-located with the service provider. In various embodiments, service provider network 150 may be implemented using any now known or later developed network interconnect, such as WIFI, wired Ethernet and the like. The service provider network 150 may be used to connect a smart device, such as a smartphone, a tablet, a smart watch, a portable computer or any other type of mobile computing device 130 of the service provider. The smart device 130 is carried by the service provider user on or about her person. Additionally, a network-connected appliance 120 may also be connected to the service provider network 150. Finally, the service provider network 150 may connect to a network-connected printer 140.

The exemplary embodiment of the system shown in FIG. 1 further incorporates a service user smart device 160, such as a smartphone, a tablet, a smart watch, a portable computer or any other type of computing device, an e-commerce system 190, a cloud based service 100 with a cloud print queue 170 for holding print jobs, as well as a third party cloud document repositories 180. All the above components are communicatively interconnected together using a cloud 110. The service user smart device 160 is carried by the service user on or about her person.

To solve the problem of automatically determining the current availability of printing services in the vicinity of the service user, one embodiment of the invention uses a mobile application, having its instances executing on the smart devices 130 and 160 of both the user and the service provider to determine the location of a service and the presence of the service provider at the service location. When the individual logged onto the aforesaid mobile application is a service provider, the instance of the mobile application on a service provider's device 130 uses geolocation services to determine if the service provider is actually present at the service location and publishes that information to the application network. Geolocation may include the GPS radio or assisted GPS (AGPS) services available within the smart device and may also include the smart device using bluetooth or wifi direct to connect to the network-connected appliance 120 described above. When the service provider leaves the proximity of the print service with her smart device, the mobile application instance automatically indicates to the service network that the service is no longer available and publishes that state so that potential users of the service are aware and don't attempt to use the service.

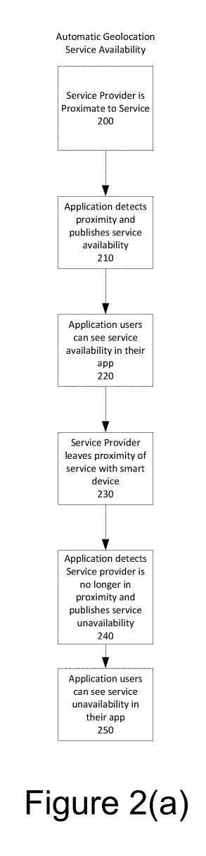

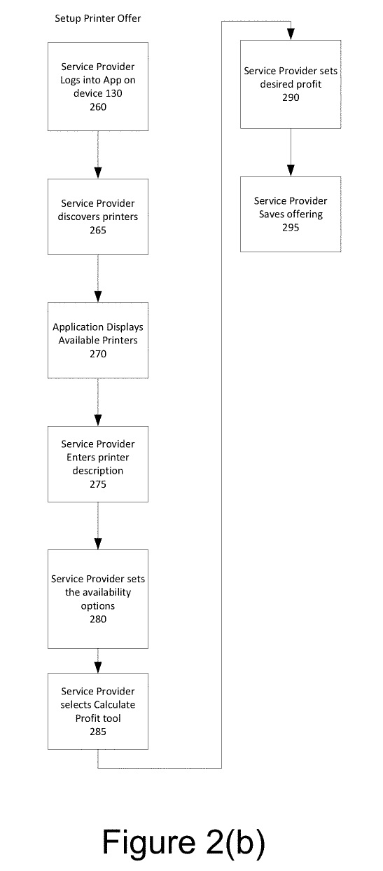

FIG. 2(a) illustrates an exemplary operating sequence of an algorithm for automatic geolocation of service availability performed in connection with the embodiments of the system illustrated in FIG. 1. At step 200, the service provider user comes to predetermined vicinity of the printing service. For example, a student offering printing service to his peers walks into her dorm room, where the printer is located. At step 210, an instance of the mobile software application executing on the service provider's smart device 130 detects proximity of the smart device 130 of the service provider user with the service location, wherein the network appliance 120 and the network printer 140 are located. In one or more embodiments, the proximity may be detected based on comparing a calculated spatial distance between the smart device 130 and the service location with a predetermined threshold value, such as, for example, 100 ft. Upon detection of the aforesaid proximity, the service availability is published (broadcast) to potential service users or an appropriate service availability record may be made in a database.

At step 220, the instance of the mobile software application, executing on the service user's smart devices 160, displays service availability to the respective service users. At step 230, the service provider user leaves the proximity of the service location with her smart device 130. At step 240, the instance of the mobile application executing on the service provider user smart device 130 detects the removal of the smart device 130 from the vicinity of the service location (e.g. the location of the network connected appliance 120) and causes the printing service to be advertised to the potential users as unavailable. At step 250, the users of the service see unavailability of the printing service in their instances of the mobile application executing on the mobile devices 160.

FIG. 2(b) illustrates an exemplary operating sequence of an algorithm for setting up a printer service offer performed in connection with the embodiments of the system illustrated in FIG. 1. First, at step 260, the service provider uses her credentials to log into instance of the mobile application executing on the service provider smart device 130. At step 265, the system performs discovery of network printers available on the service provider's network 150. At step 270, the instance of the mobile application executing on the service provider smart device 130 displays the available network printers. At step 275, the service provider enters network printer description.

At step 280, the service provider sets the service availability options, which may include the days and times when the service is available. At step 285, the service provider selects the profit calculation tool within the instance of the mobile application. At step 290, the service provider selects the desired profit in the profit calculation tool. Finally, at step 295, the service provider saves the specified service offering.

In one or more embodiments, the described instance of mobile application executing on the service user's smart device 160 provides a function for searching nearby printing service providers and displaying the prices they currently have active for each printer model and print type. In order to search for nearby services, one embodiment described herein leverages the GPS radio or assisted GPS (AGPS) of the smart device 130 and/or 160 to establish a radius around each printing service location.

In one or more embodiments, when the service provider is available and the provider is within their designated service hours, the mobile application instance executing on a user's smart device 160 shows the availability of the print service. In one or more embodiments, the service provider's location appears available on a map displayed by the mobile application instance and the service user can go to that location to obtain print service. Through the same instance of the mobile application, the service user is shown the rate (e.g. per-page price for printing) that the service provider has advertised to the service network. The aforesaid mobile application instance enables the user to accept the advertised pricing and available print options (color vs. monochrome; single sided vs. double, etc.) and can release a document from a cloud document repository, such as the third party cloud document repositories 180, to print to the network-connected printer 140. In one or more embodiments, the cloud printing service is accomplished through the network-connected appliance 120, which connects the cloud printing service described herein to the network printer 140. The service user is charged the per-page rate that the service provider has specified in the system for the number of pages printed.

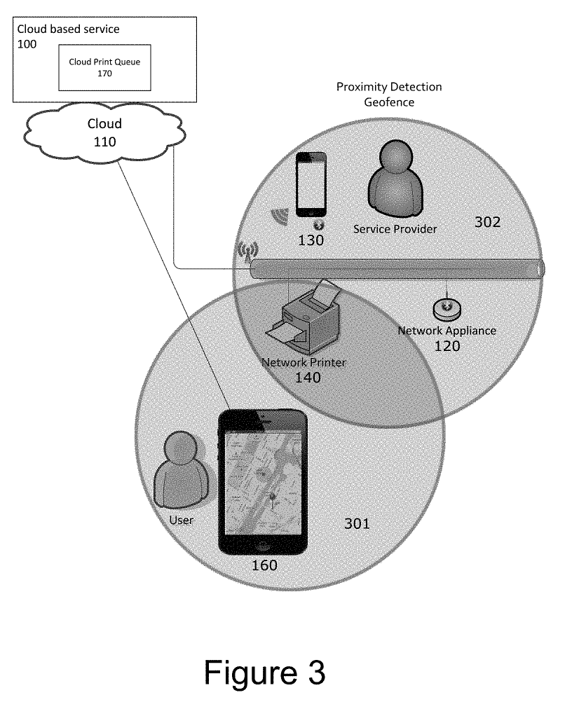

One embodiment of the inventive system enforces the service user's proximity to the printing service before the print job can be released to the network-connected printer 140. This means that the geolocation proximity circles 301 and 302 of the service user and the service provider, respectively, as determined by the geolocations of the smart devices 160 and 130, must overlap the location of the network-connected printer 140's service location, see FIG. 3. This ensures that the printing service is available and the service user is sufficiently proximate to be able to retrieve the print.

Another embodiment allows the service user to use the instance of the mobile application to send a notification to the instance of the mobile application of the service provider requesting a specific time for the service provider to be available. If the service provider accepts the request, the mobile application can set a reminder and alarm as the meeting time approaches. If the service provider is not proximate to the service location as the time approaches, the instance of the mobile application of the service provider can warn the service provider that they need to navigate to the service location to make the service available.

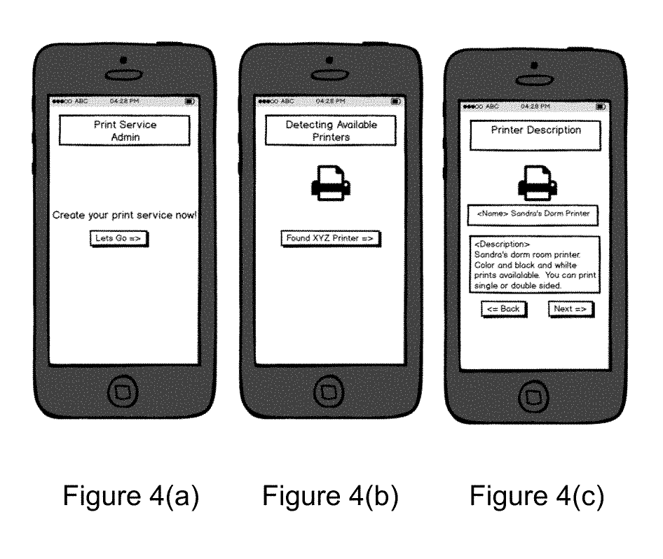

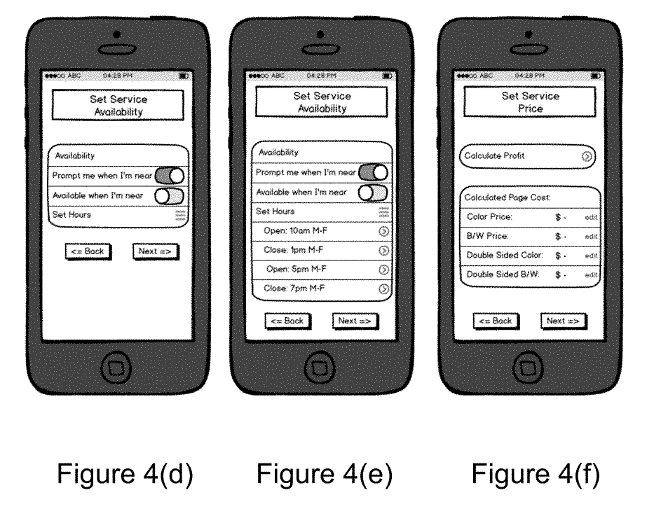

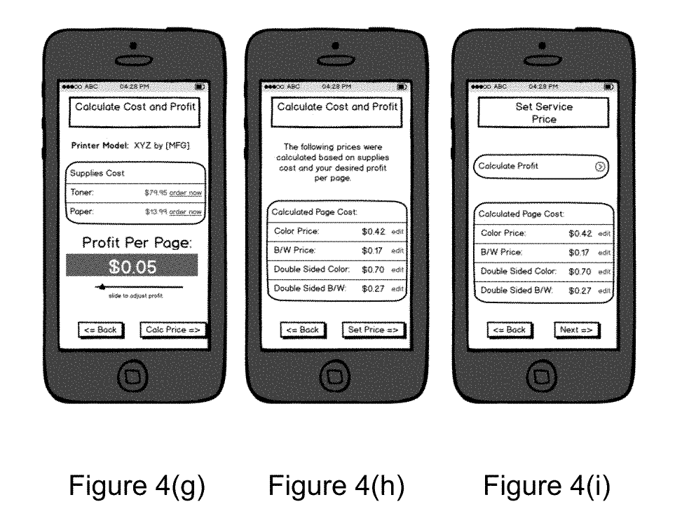

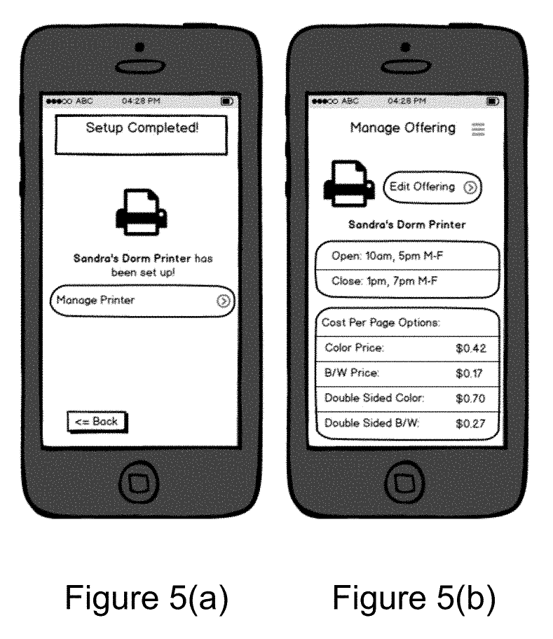

In one or more embodiments, as stated above, the instance of the mobile application of the service provider enables the service provider to identify the network-connected printer, specify service availability and define a cost per page offering for the printer. Specifically, FIGS. 4(a), 4(b) and 4(c) illustrate various exemplary embodiments of the user interfaces of the service provider's application instance for detecting all available network printers, as well as for entering the name and description of each detected printer. FIGS. 4(d) and 4(e) illustrate exemplary embodiments of user interfaces for setting printing service availability. FIGS. 4(f) and 4(i) illustrate exemplary embodiments of a user interfaces for setting printing cost per page for printing service. FIGS. 5(a) and 5(b) illustrate exemplary embodiments of a user interfaces for managing the printer service offering.

In one or more embodiments, the instance of the mobile application of the service provider also enables the service provider to order consumable supplies for the printing service and, as a result of that activity, to maintain a running history wherein the description of the product, ordered quantity and price per unit is recorded and stored for future use in the service provider's account established in the cloud service. In one or more embodiments, the cloud service 100 is connected to one or multiple third party eCommerce systems 190 to order various consumable supplies for the service provider's printer. Those third parties are the maintainers of the pricing that is eventually stored and preserved for historical use within the cloud service 100.

FIGS. 4(g), 4(h) and 4(i) illustrate various embodiment of the graphical user interface of the mobile application for performing cost and profit calculations and for setting the appropriate service price.

In one or more embodiments, using the historical purchase information the service provider's instance of the mobile application is able to present the service provider with what their cost of consumables is/has been. This is important as it provides the service provider with historically accurate data so they can confidently price their print offering and know that they are making a profit. The mobile application not only curates the data from the service provider's account in the cloud service 100, but it provides a simple, intuitive interface for manipulating the profit analysis. After the service provider is done running their various scenarios and is comfortable with the price and profit they have achieved they can easily advertise the price to the print service so that it becomes publically available. In one or more embodiments, the instance of the mobile application may also prompt the service provider to specify date/time when the specify price becomes effective.

Various embodiments allow the service provider manipulate the per-print price and/or their profit. One exemplary embodiment allows a service provider the ability to enter custom parameters for inclusion in the per-print calculation. An example of this might be the cost of electricity for powering the printer that is part of the print service.

Another exemplary embodiment allows the service provider to enter their own prices for consumables so they can calculate prices for those items that they may have purchased outside of the normal purchase channel. By allowing this, the service 100 may have a greater appeal as it doesn't lock down a service provider to one particular source of consumables. It also has the benefit of allowing the service provider more flexibility in discovering how to maximize their profitability by sourcing consumables from one source or another.

Another exemplary embodiment would allow the service provider the ability to connect in real time to the third party eCommerce systems 190 to bring in real time pricing. This allows the service provider the ability to look at where the cost base is headed on their next purchase and from that information the service provider can change their prices proactively. It also is easy as everything is performed within the instance of the mobile application and it does not require the service provider to manually lookup and transfer pricing between different applications.

As would be appreciated, the above description dealt with printer service. On the other hand, the inventive concepts described herein are not limited to printer service only. Any other type of substantially standardized service that may be offered by one user to another, such as scanning, may be used in connection with the described systems and methods. Therefore, the described embodiments are not limited to printing service only.

### Computing Platforms

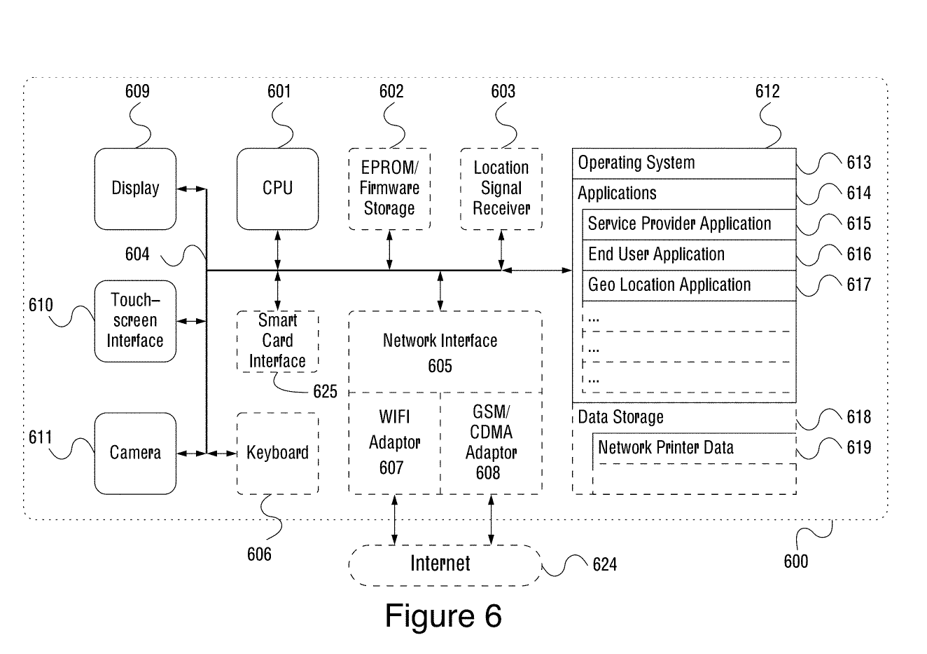

FIG. 6 illustrates an exemplary embodiment of a computerized system 600 that could be used as the smart device 130 and 160 or the network-connected appliance 120 in connection with the system shown in FIG. 1. In one or more embodiments, the computerized system 600 may be implemented within a form factor of a mobile computing device, such as a smartphone, a personal digital assistant (PDA), a tablet computer, or a smart watch. In an alternative embodiment, the computerized system 600 may be implemented based on a laptop, a notebook or a desktop computer. Yet in an alternative embodiment, the computerized system 600 may be an embedded system, incorporated into an electronic device with certain specialized functions, such as an electronic book (or e-book) reader, scanner or copier. Yet in an alternative embodiment, the computerized system 600 may be implemented as a part of an augmented reality head-mounted display (HMD) systems, such as Google glass, also well known to persons of ordinary skill in the art.

The computerized system 600 may include a data bus 604 or other interconnect or communication mechanism for communicating information across and among various hardware components of the computerized system 600, and a central processing unit (CPU or simply processor) 601 coupled with the data bus 604 for processing information and performing other computational and control tasks. Computerized system 600 also includes a memory 612, such as a random access memory (RAM) or other dynamic storage device, coupled to the data bus 604 for storing various information as well as instructions to be executed by the processor 601. The memory 612 may also include persistent storage devices, such as a magnetic disk, optical disk, solid-state flash memory device or other non-volatile solid-state storage devices.

In one or more embodiments, the memory 612 may also be used for storing temporary variables or other intermediate information during execution of instructions by the processor 601. Optionally, computerized system 600 may further include a read only memory (ROM or EPROM) 602 or other static storage device coupled to the data bus 604 for storing static information and instructions for the processor 601, such as firmware necessary for the operation of the computerized system 600, basic input-output system (BIOS), as well as various configuration parameters of the computerized system 600.

In one or more embodiments, the computerized system 600 may incorporate a display device 609, which may be also coupled to the data bus 604, for displaying various information to a user of the computerized system 600, such as the graphical user interface screens shown in FIGS. 4, 5(a) and 5(b). In an alternative embodiment, the display device 609 may be associated with a graphics controller and/or graphics processor (not shown). The display device 609 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 609 may be incorporated into the same general enclosure with the remaining components of the computerized system 600. In an alternative embodiment, the display device 609 may be positioned outside of such enclosure.

In one or more embodiments, the computerized system 600 may further incorporate a smart card interface 625 connected to the data bus 604 and configured to read information encoded on a smart card inserted by the end user. This encoded information may contain end user's credentials.

In one or more embodiments, the computerized system 600 may incorporate one or more input devices, such as a touchscreen interface 610 for receiving tactile commands, a camera 611 for acquiring still images and video of various objects, as well as a keyboard 606, which all may be coupled to the aforesaid data bus 604 for communicating information, including, without limitation, images and video, as well as user command selections to the processor 601. In an alternative embodiment, input devices may include a system for tracking eye movements of the user (not shown), which may be used to indicate to the computerized system 600 the command selection by the user. In yet alternative embodiment, the computerized system 600 may incorporate a voice command interface for receiving voice control commands from the user.

In one or more embodiments, the computerized system 600 may additionally include a location signal receiver 603 configured to perform scan for GPS signal(s), determine the geographical location of the computerized system 600 based on the detected GPS signal(s) and communicate the determined geographical location information to the processor 601 via the data bus 604. The location determined as described herein may be used as described above to determine the proximity of the user and/or service provider to the printing service.

In one or more embodiments, the computerized system 600 may additionally include a communication interface, such as a network interface 605 coupled to the data bus 604. The network interface 605 may be configured to establish a connection between the computerized system 600 and the Internet 624 using at least one of WIFI interface 607 and the cellular network (GSM or CDMA) adaptor 608. The network interface 605 may be configured to provide a two-way data communication between the computerized system 600 and the Internet 624. The WIFI interface 607 may operate in compliance with 802.11a, 802.11b, 802.11g and/or 802.11n protocols as well as Bluetooth protocol well known to persons of ordinary skill in the art. In an exemplary implementation, the WIFI interface 607 and the cellular network (GSM or CDMA) adaptor 608 send and receive electrical or electromagnetic signals that carry digital data streams representing various types of information.

In one or more embodiments, the Internet 624 typically provides data communication through one or more sub-networks to other network resources. Thus, the computerized system 600 is capable of accessing a variety of network resources located anywhere on the Internet 624, such as web servers, other content servers as well as other network data storage resources. In one or more embodiments, the computerized system 600 is configured to send and receive messages, media and other data, including application program code, through a variety of network(s) including Internet 624 by means of the network interface 605. In the Internet example, when the computerized system 600 acts as a network client, it may request code or data for an application program executing on the computerized system 600. Similarly, it may act as a network server and send various data or computer code to other network resources.

In one or more embodiments, the computerized system 600 uses the network interface 605 to send request(s), via the Internet 624, such as HTTP requests, to the various servers and receive various information. Some of the received information may be displayed to the user using the aforesaid user interfaces shown in FIGS. 4(a) through 4(i), 5(a) and 5(b).

In one or more embodiments, the functionality described herein is implemented by computerized system 600 in response to processor 601 executing one or more sequences of one or more instructions contained in the memory 612. Such instructions may be read into the memory 612 from another computer-readable medium. Execution of the sequences of instructions contained in the memory 612 causes the processor 601 to perform the various process steps described herein. In alternative embodiments, hard-wired circuitry may be used in place of or in combination with software instructions to implement the embodiments of the invention. Thus, embodiments of the invention are not limited to any specific combination of hardware circuitry and/or software.

The term “computer-readable medium” as used herein refers to any medium that participates in providing instructions to processor 601 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 901 for execution. For example, the instructions may initially be carried on a magnetic disk from a remote computer. Alternatively, a remote computer can load the instructions into its dynamic memory and send the instructions over the Internet 624. Specifically, the computer instructions may be downloaded into the memory 612 of the computerized system 600 from the foresaid remote computer via the Internet 624 using a variety of network data communication protocols well known in the art.

In one or more embodiments, the memory 612 of the computerized system 600 may store any of the following software programs, applications or modules:

1. Operating system (OS) 613, which may be a mobile operating system for implementing basic system services and managing various hardware components of the computerized system 600. Exemplary embodiments of the operating system 613 are well known to persons of skill in the art, and may include Mac OS, iOS, Android, Windows, Windows Mobile, Linux, Unix or any other now known or later developed operating system(s).

2. Applications 614 may include, for example, a set of software applications executed by the processor 601 of the computerized system 600, which cause the computerized system 600 to perform certain predetermined functions, such as generate the graphical user interface screens shown in FIGS. 4(a) through 4(i), 5(a) and 5(b). In one or more embodiments, the applications 614 may include, for example, a Service Provider Application Instance 615, an End User (Service User) Application Instance 616 and/or Geo-Location Application 617.

3. Data storage 618 may be used, for example, for storing information 619 about available network-connected printers 140, various pricing information, as well as any other suitable information.

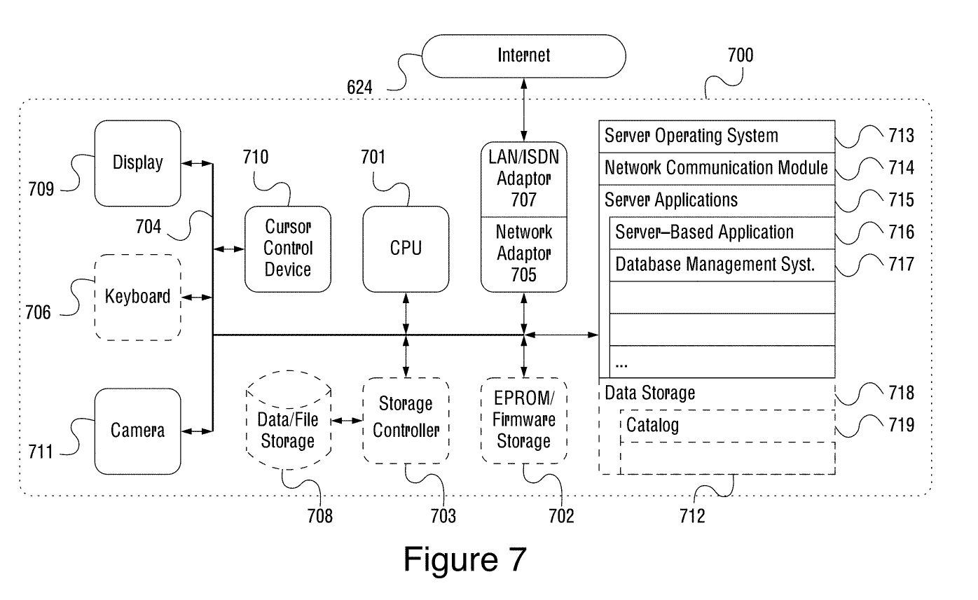

FIG. 7 illustrates an exemplary embodiment of a computerized server system 700 which could be used, for example, as a computer platform for the cloud service 100 or cloud document repositories 190 of the system shown in FIG. 1.

In one or more embodiments, the computerized server system 700 may incorporate a data bus 704, which may be substantially similar and may perform substantially similar functions as the data bus 704 of the computerized system 600 illustrated in FIG. 6. In various embodiments, the data bus 704 may use the same or different interconnect and/or communication protocol as the data bus 604. The one or more processors (CPUs) 701, the network adaptor 705, the EPROM/Firmware storage 702, the display device 709 and the keyboard 706 of the computerized server system 700 may be likewise substantially similar to the respective processor 601, the network interface 605, the EPROM/Firmware storage 602, the display device 609 and the keyboard 606 of the computerized system 600, except that the former components are deployed in a server platform configuration. In various implementations, the one or more processor 701 may have substantially increased processing power as compared with the processor 601.

In addition to the input device 706 (keyboard), the computerized server system 700 may additionally include a cursor control device 710, such as a mouse, a trackball, or cursor direction keys for communicating direction information and command selections to processor 701 and for controlling cursor movement on the display device 709. This input device typically has two degrees of freedom in two axes, a first axis (e.g., x) and a second axis (e.g., y), that allows the device to specify positions in a plane.

The LAN/ISDN adaptor 707 of the computerized server system 700 may be implemented, for example, using an integrated services digital network (ISDN) card or a modem to provide a data communication connection to a corresponding type of telephone line, which is interfaced with the Internet 624 using Internet service provider's hardware (not shown). As another example, the LAN/ISDN adaptor 707 may be a local area network interface card (LAN NIC) to provide a data communication connection to a compatible LAN and the Internet 624. To store various data files, such as firmware and/or driver files, the computerized server system 700 may be provided with storage 708, connected to the data bus 704 by means of a storage controller 703. The camera 711 may be used to acquire images and/or video of various objects.

In one or more embodiments, the memory 712 of the computerized server system 700 may store any of the following software programs, applications, modules and/or data:

1. A server operating system (OS) 713, which may be an operating system for implementing basic system services and managing various hardware components of the computerized server system 700. Exemplary embodiments of the server operating system 713 are all well known to persons of skill in the art, and may include Windows Server, Mac OS, Unix, AIX, FreeBSD, Linux, as well as any now known or later developed operating systems.

2. A network communication module 714 may incorporate, for example, one or more network protocol stacks which are used to establish a networking connection between the computerized server system 700 and the various network entities of the Internet 624, such as the computerized system 600, using the network adaptor 705 working in conjunction with the LAN/ISDN adaptor 707.

3. Server applications 715 may include, for example, a set of software applications executed by one or more processors 701 of the computerized server system 700, which cause the computerized server system 700 to perform certain predetermined functions or tasks. In one or more embodiments, the server applications 715 may include the server-based application 716, for performing cloud service functions described in detail above. Additionally provided may be a database management system 717 for storing and managing access to various information, as described in detail above, such as documents stored in the cloud document repository 190.

4. Data storage 718 may be used, for example, for storing the aforesaid information, including the catalog 719 of the documents stored in the cloud document repository 190, which may be stored in a form of one or more database tables and/or database objects, such as relational database tables and objects.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, Android as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in various systems and methods for geofencing for service availability and dynamic profit calculation. It is intended that the specification and examples be considered as exemplary only, with a true scope and spirit of the invention being indicated by the following claims.

1. A computerized system for managing a printing service, the system comprising:
a. a network-connected printer disposed on a local area network;
b. a cloud-based printing service comprising a printing queue holding at least one print job;
c. a service provider smart device comprising a first processing unit, a first memory and a display;
d. a network-connected appliance device disposed on the local area network and communicatively coupled with the network-connected printer, the network-connected appliance device comprising a second processing unit and a second memory and configured to determine a status of the network-connected printer, connect to the cloud-based printing service and communicate the determined status of the network-connected printer to the cloud-based printing service; and
e. a printing service user smart device separate and distinct from the service provider smart device,
wherein the service provider smart device is configured to generate a graphical user interface on the display and receive, using the generated graphical user interface, a printing service information comprising at least one characteristic of the printing service from a service provider and to communicate the received printing service information to the cloud-based printing service and wherein the printing service user smart device is configured to receive the printing service information from the cloud-based printing service and to display at least a portion of the received printing service information to a printing service user.

2. The computerized system of claim 1, wherein the printing service information comprises availability options of the printing service.

3. The computerized system of claim 2, wherein the availability options comprise days and hours of availability of the printing service.

4. The computerized system of claim 1, wherein the printing service information comprises pricing information of the printing service.

5. The computerized system of claim 1, wherein the printing service information comprises pricing information of the printing service.

6. The computerized system of claim 1, wherein the printing service information comprises location information of the printing service.

7. The computerized system of claim 1, wherein the printing service information comprises a description of the network-connected printer.

8. The computerized system of claim 1, wherein the cloud-based printing service is configured to transmit the communicated printing service information to the printing service user smart device.

9. The computerized system of claim 1, wherein the service provider smart device is further configured to obtain pricing information associated with consumables for the network-connected printer and to automatically calculate cost associated with the printing service.

10. The computerized system of claim 1, wherein the service provider smart device is further configured to obtain pricing information associated with consumables for the network-connected printer and to automatically calculate profit associated with the printing service.

11. The computerized system of claim 10, wherein the pricing information associated with consumables for the network-connected printer is received from the service provider.

12. The computerized system of claim 10, wherein the pricing information associated with consumables for the network-connected printer is received from a third party ecommerce system.

13. The computerized system of claim 1, wherein the service provider smart device is configured to detect a current geo-location and to automatically communicate to the cloud-based printing service that the printing service is available when the detected current geo-location is within a predetermined vicinity of the network-connected appliance device or the network-connected printer.

14. The computerized system of claim 13, wherein when the printing service is available, the one or more print jobs could be sent to the network-connected printer.

15. The computerized system of claim 1, wherein the service provider smart device is configured to detect a current geo-location and to automatically communicate to the cloud-based printing service that the printing service is unavailable when the detected current geo-location is outside a predetermined vicinity of the network-connected appliance device or the network-connected printer.

16. The computerized system of claim 15, wherein when the printing service is unavailable, the one or more print jobs are prevented from being sent to the network-connected printer.

17. The computerized system of claim 15, wherein the printing service user smart device is configured to detect a current geo-location and display the network-connected printer as available to a service user when the detected current geo-location is within a predetermined vicinity of the network-connected appliance device or the network-connected printer.

18. The computerized system of claim 15, wherein the printing service user smart device is configured to detect a current geo-location and display the network-connected printer as unavailable to a service user when the detected current geo-location is outside of a predetermined vicinity of the network-connected appliance device or the network-connected printer.

19. The computerized system of claim 1, wherein the printing service user smart device is configured to detect a first geo-location, wherein the service provider smart device is configured to detect a second geo-location and wherein the printing service user smart device is configured to display the network-connected printer as available to a service user when both the detected first geo-location is within a predetermined first vicinity of the network-connected appliance device or the network-connected printer and the detected second geo-location is within a predetermined second vicinity of the network-connected appliance device or the network-connected printer.

20. The computerized system of claim 1, wherein the printing service user smart device is configured to detect a first geo-location, wherein the service provider smart device is configured to detect a second geo-location and wherein the printing service user smart device is configured to display the network-connected printer as unavailable to a service user when either the detected first geo-location is outside of a predetermined first vicinity of the network-connected appliance device or the network-connected printer or the detected second geo-location is outside a predetermined second vicinity of the network-connected appliance device or the network-connected printer.

21. A computer-implemented method for managing a printing service, the computer-implemented method performed in connection with a computerized system comprising: a network-connected printer disposed on a local area network, a cloud-based printing service comprising a printing queue holding at least one print job, a service provider smart device comprising a first processing unit, a first memory and a display, a network-connected appliance device disposed on the local area network and communicatively coupled with the network-connected printer, the network-connected appliance device comprising a second processing unit and a second memory, and a printing service user smart device separate and distinct from the service provider smart device, the computer-implemented method comprising:
a. determining, by the network-connected appliance device, a status of the network-connected printer, connect to the cloud-based printing service and communicate the determined status of the network-connected printer to the cloud-based printing service;
b. generating, by the service provider smart device, a graphical user interface on the display and receiving, using the generated graphical user interface, a printing service information comprising at least one characteristic of the printing service from a service provider;
c. communicating the received printing service information to the cloud-based printing service,
d. receiving, by the printing service user smart device, the printing service information from the cloud-based printing service; and
e. displaying, by the printing service user smart device, at least a portion of the printing service information to a user of the printing service.

22. A non-transitory computer-readable medium embodying a set of computer-executable instructions, which, when executed in connection with a computerized system comprising: a network-connected printer disposed on a local area network, a cloud-based printing service comprising a printing queue holding at least one print job, a service provider smart device comprising a first processing unit, a first memory and a display, a network-connected appliance device disposed on the local area network and communicatively coupled with the network-connected printer, the network-connected appliance device comprising a second processing unit and a second memory, and a printing service user smart device separate and distinct from the service provider smart device, cause the computerized system to perform a method for managing a printing service, the method comprising:
a. determining, by the network-connected appliance device, a status of the network-connected printer, connect to the cloud-based printing service and communicate the determined status of the network-connected printer to the cloud-based printing service;
b. generating, by the service provider smart device, a graphical user interface on the display and receiving, using the generated graphical user interface, a printing service information comprising at least one characteristic of the printing service from a service provider;
c. communicating the received printing service information to the cloud-based printing service,
d. receiving, by the printing service user smart device, the printing service information from the cloud-based printing service; and
e. displaying, by the printing service user smart device, at least a portion of the printing service information to a user of the printing service.
